(19) United States
(12) Patent Application Publication
(10) Pub. No.: US 2018/0293527 A1
(43) Pub. Date: Oct. 11, 2018

(54) METHODS AND SYSTEM FOR WAREHOUSE DOCK LOGISTICS

(71) Applicant: Home Depot Product Authority, LLC, Atlanta, GA (US)

(72) Inventors: Feridoun Amirjalayer, Atlanta, GA (US); Matthew D. Graham, Marietta, GA (US); Charles Hagin, Marietta, GA (US)

(21) Appl. No.: 15/482,035

(22) Filed: Apr. 7, 2017

(51) Int. Cl. G06Q 10/06; G06Q 10/08

(52) U.S. Cl. CPC G06Q 10/06311; G06Q 10/087

(57) ABSTRACT

A system for organizing assignments of each of a plurality of trailers to a plurality of docks in a warehouse may include a non-transitory computer-readable memory containing computer-executable instructions and a processor. The processor may be configured to execute the instructions to (a) receive data comprising (i) an amount of time that each of a plurality of trailers has been at the warehouse; (ii) contents to be unloaded from each of the plurality of trailers; and (iii) content constraints associated with a plurality of docks in a warehouse, (b) reduce the data to a computer-solvable linear problem, (c) solve the linear problem to minimize an amount of time that each of the plurality of trailers spends at the warehouse, wherein the solution to the linear problem comprises an assignments of one of the plurality of trailers to one of the plurality of docks, and (d) output the assignment.

### FIELD OF THE DISCLOSURE

This disclosure is generally directed to logistics within a warehouse, including the assignment of trailers to docks for unloading and/or loading and the assignment of labor resources to trailers for loading and/or unloading.

### BACKGROUND OF RELATED ART

Warehouses may receive a large volume of many different types of goods from many different sources in many different forms of packaging. Accordingly, a warehouse may have a large number of loading and unloading docks, each with its own placement and equipment to accommodate particular types of goods or particular forms of packaging. Matching incoming trailers to appropriate docks, therefore, is an important task in management of a warehouse to ensure proper loading and unloading of goods. Such assignments are currently determined manually, based on the judgment of an operator of the warehouse.

### SUMMARY

A system for organizing assignments of each of a plurality of trailers to a plurality of docks in a warehouse may include a non-transitory computer-readable memory containing computer-executable instructions and a processor. The processor may be configured to execute the instructions to (a) receive data comprising (i) an amount of time that each of a plurality of trailers has been at the warehouse; (ii) contents to be unloaded from each of the plurality of trailers; and (iii) content constraints associated with a plurality of docks in a warehouse, (b) reduce the data to a computer-solvable linear problem, (c) solve the linear problem to minimize an amount of time that each of the plurality of trailers spends at the warehouse, wherein the solution to the linear problem comprises an assignments of one of the plurality of trailers to one of the plurality of docks, and (d) output the assignment.

A method for organizing assignments of each of a plurality of trailers to a plurality of docks in a warehouse may include (a) receiving data comprising (i) an amount of time that each of a plurality of trailers has been at the warehouse; (ii) contents to be unloaded from each of the plurality of trailers; and (iii) content constraints associated with a plurality of docks in a warehouse, (b) reducing the data to a computer-solvable linear problem, (c) solving the linear problem with a processor to minimize an amount of time that each of the plurality of trailers spends at the warehouse, wherein the solution to the linear problem comprises an assignment of one of the plurality of trailers one of the plurality of docks, and (d) outputting the assignment.

### BRIEF DESCRIPTION OF THE DRAWINGS

FIG. 1 is a diagrammatic view of an example embodiment of a system for warehouse dock logistics.

FIG. 2 is an example user interface that may be output by the system of FIG. 1.

FIG. 3 is a flow chart illustrating an example embodiment of a method for determining trailer assignments in a warehouse.

FIG. 4 is a diagrammatic view of an illustrative computing system that includes a general purpose computing system environment.

### DETAILED DESCRIPTION

Currently techniques for assigning trailers to docks in a warehouse can be improved upon. For example, by applying a mathematical optimization to available data, trailers can be assigned to docks to minimize the amount of time that trailers spend on the warehouse premises, to minimize the amount of labor required to unload each trailer, and/or to accomplish other goals. For example, in an embodiment, data that may be taken into account in such a mathematical optimization technique may include the contents of the incoming trailers, the capabilities of each of the docks at the warehouse (e.g., the amounts of goods and package forms that each dock is designed for), the labor available at each dock, and other information. Assigning trailers to docks according to the present disclosure may transform a traditionally subjective process performed by human operators into a mathematically automated process executed on computers.

The instant inventors have appreciated that linear problem solving is one particular mathematical optimization technique that may be advantageously applied to determinations of trailer-to-dock assignments to improve efficiency of a warehouse. For example, application of computerized linear problem solving to trailer-to-dock assignments has been shown by the instant inventors to improve efficiency of a warehouse by up to six percent.

The teachings of the instant disclosure may be employed in a warehouse that receives goods on inbound trailers from a number of sources and redistributes those goods for delivery to specific destinations (e.g., specific retail locations) on outbound trailers, in an embodiment. Manual assignments of trailers to docks in such warehouses may not adequately address stock shortages at destinations of goods. That is, manual trailer assignments may not adequately ensure rapid unloading of goods needed to replenish low stock or out of stock destinations. In contrast, determining trailer assignments according to the present disclosure may optimize assignment of trailers containing replenishment goods, among other advantages. Therefore, in addition to improving the efficiency within the warehouse itself, the application of the instant teachings can improve the operations of retail and other outlets that receive goods from the warehouse by reducing the time that goods may be in low stock or out of stock.

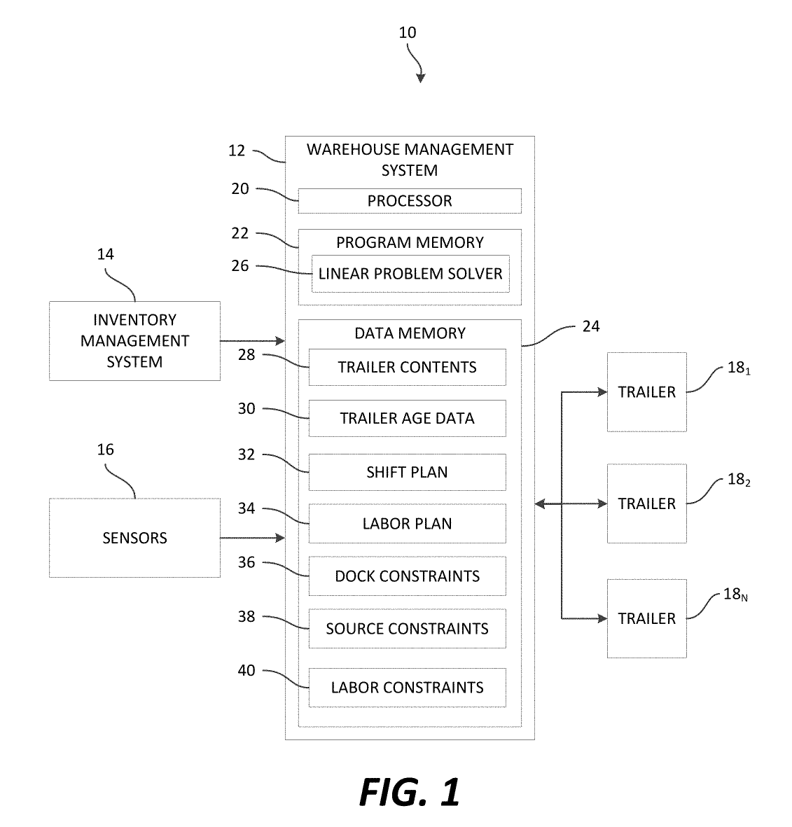

Referring to the drawings, wherein like numerals refer to the same or similar features in the various views, FIG. 1 is a diagrammatic view of an example embodiment of a system 10 for determining trailer-to-dock assignments in a warehouse, among other things. The system 10 may include a warehouse management system 12 in electronic communication with an inventory management system 14 and a plurality of sensors 16. The warehouse management system 12 may also be in communication with a plurality of trailers 18₁, 18₂, . . . , 18_{N}, in an embodiment. The trailers 18₁, 18₂, . . . , 18_{N} may be referred to individually as a trailer 18, or collectively as the trailers 18.

This disclosure makes reference to communications to and from a trailer 18. It should be understood that such communications may in fact be to and from an operator of a trailer 18 (e.g., a driver of a truck to which the trailer 18 is coupled, a dispatch operator for the trailer 18, etc.).

The warehouse management system 12 may be implemented at and/or accessed from a warehouse, in an embodiment, and may provide many functions for introducing goods to a warehouse, routing goods through a warehouse, and/or loading goods to leave a warehouse, in an embodiment. For example, as will be described in greater detail, the warehouse management system 12 may determine, among other things, trailer assignments in a warehouse and labor assignments in a warehouse.

The warehouse management system 12 will be described with reference to an embodiment in which the warehouse management system 12 is used in a single warehouse having a plurality of docks. Such description is by way of example only. Furthermore, it should be noted that the warehouse management system may include the functionality and structure described herein. In addition, the warehouse management system may perform some or all of the functionality that is generally ascribed to a “warehouse management system” as that term is generally used in industry. In embodiments, however, a warehouse management system according to the present disclosure need not include any of the functionality that is generally ascribed to a “warehouse management system” as that term is generally used in industry.

The instant disclosure makes reference to “dock assignments” and “trailer assignments.” It should be understood that both of these terms refer to the assignment of trailers 18 to respective docks in the warehouse for unloading and/or loading. Furthermore, it should be understood that “labor assignments,” when used herein, refer to the assignment of labor resources to unload and/or load a trailer at a dock.

The warehouse management system 12 may include a processor 20, a program memory 22, and a data memory 24. The program memory 22 may store instructions that may be executed by the processor 20 to perform one or more of the methods, techniques, steps, etc. of this disclosure. A linear problem solver 26 may be included in the program memory 22. The data memory 24 may include data respective of the contents of the trailers 28, trailer age data 30, shift plan data 32, labor plan data 34, dock constraint data 36, labor constraint data 38, and source constraint data 40, in an embodiment.

Some or all of the functionality of the warehouse management system 12 described in this disclosure may be provided in hardware and/or software local to a particular warehouse, in an embodiment. Additionally or alternatively, some or all of the functionality of the warehouse management system 12 may be provided in hardware and/or software remote from the warehouse. For example, in an embodiment, the warehouse management system 12 may include cloud-based software accessible from a browser at the warehouse.

The warehouse management system 12 may be configured to determine trailer assignments based on data from the inventory management system 14, data from the sensors 16, and data from the data memory 24, in an embodiment. For example, the warehouse management system 12 may be configured to reduce that data to a computer-solvable linear problem, in an embodiment. The warehouse management system 12 may further be configured to solve that linear problem to generate an output (e.g., with the linear problem solver 26), in an embodiment. The output of the linear problem—i.e., the solution—may include an assignment of at least one trailer 18 to at least one dock. In an embodiment, the solution to the linear problem may include assignments of one or more of the trailers 18 to each of a plurality of docks at a warehouse and/or an assignment of labor to one or more of the docks (e.g., to unload the assigned trailers 18).

The linear problem may be arranged and solved by the warehouse management system 12 to minimize or maximize one or more values, in an embodiment. For example, in an embodiment, the linear problem may be solved to minimize the amount of labor required for a planned total goods throughput for a period of time (e.g., a labor shift) according to the age of expected trailers and in-stock status of the contents of trailers. For example, solving the linear problem may include a determination that to stay current on a shift, based on the on-premises trailers and trailers anticipated during the shift, that the warehouse needs to process a certain number of a certain type of package, such as cartons. For example, a warehouse may include several docks that can unload the package type, each involving different amounts of labor and different unload rates. The solution to the linear problem may account maximize the utilization of docks that require minimal labor, but may also utilize high-labor docks as needed, for example.

Additionally or alternatively, the linear problem may be solved to minimize the amount of time each trailer spends at the warehouse (i.e., the “age” of each trailer) and/or to maximize the utilization of outbound trailers.

The linear problem solver 26 may be or may include a commercially-available linear problem solving tool such as, for example, the IBM ILOG CPLEX Optimization tool, in an embodiment. Additional or alternative computer-based linear problem solvers may be used, in embodiments.

The inventory management system 14 may store or have access to records of inventory and/or stock of one or more products, among other information. For example, the inventory management system 14 may include records of inventory and/or stock of products that are, were, and/or will be supplied through a warehouse that uses the warehouse management system 12. In an embodiment, the inventory management system 14 may include records of products available through a particular retail outlet, such as inventory for in-store and/or online sales. The warehouse management system 12 may be in electronic communication with the inventory management system 14 to determine inventory needs of one or more destinations of the contents to be unloaded from each of a plurality of trailers 18 at the warehouse. For example, the inventory management system 14 may provide stock information to the warehouse management system 12, so that the warehouse management system 12 may account for inventory needs (e.g., a low-stock or out-of-stock status for a particular product or products) of one or more stores in determining trailer assignments, in an embodiment. The stock information received by the warehouse management system 12 from the inventory management system 14 may include specific locations (e.g., retail locations) and specific products for which additional stock is needed more quickly than usual, in an embodiment.

One or more sensors 16 may be provided in the warehouse to track the status of one or more trailers 18, in an embodiment, such as the respective locations of trailers, the unloading status of trailers, etc. For example, the sensors 16 may include one or more bar code scanners or other sensors disposed in or around the warehouse that may be used to scan packages as those packages are unloaded from trailers 18, moved through the warehouse, and/or loaded onto trailers 18 at the warehouse. The warehouse management system 12 may utilize data from the sensors 16 to, e.g., determine the status of a trailer 18 being loaded or unloaded (e.g., the percentage completed of unloading or loading of an individual trailer). A trailer's unloading status may be defined as a variable in a linear problem to be solved, in an embodiment, as discussed further below. Accordingly, the warehouse management system may be configured to determine trailer assignments according to data from sensors 16 that continuously monitor the status of trailers 18 at the warehouse.

The trailer contents data 28 may include data indicative of the contents of one or more trailers 18 that are expected at the warehouse within a selected period of time (e.g., within the current shift, day, or week, the next shift, day, or week, etc.), of one or more trailers 18 that are currently at the warehouse, and/or of one or more trailers 18 that were loaded at and have left the warehouse. The trailer contents data 28 may include information on an item-by-item basis, on a package-by-package basis (e.g., wherein a package may be a pallet, carton, etc.), and/or on some other basis. In an embodiment, the trailer contents data 28 may include information indicative of the packing arrangement of contents within one or more trailers 18 (i.e., how particular goods or packages are arranged within an individual trailer). The trailer contents data may be received by the warehouse management system from an origin or dispatch of respective trailers, in an embodiment.

The trailer age data 30 may include data indicative of the age of one or more trailers 18 on the warehouse premises, in an embodiment. The warehouse management system 12 may be configured to track the age of one or more trailers 18 on the premises of the warehouse, in an embodiment. For example, the warehouse management system 12 may receive a notification when each trailer 18 arrives to the warehouse premises. Such a notification may be received by the warehouse management system 12 from the trailers 18, in an embodiment, and/or from one or more of the sensors 16 (e.g., a camera). After receiving such a notification, the warehouse management system 12 may record and store the age of each trailer 18 for use in determining trailer-to-dock assignments.

The shift plan data 32 may be or may include a variety of data regarding expected incoming and outgoing goods over a given period of time (for example, for a single labor shift at the warehouse). In an embodiment, the shift plan data 32 may include an expected number of packages that are expected during the shift or other expected volume of goods, which may be based on information received externally (i.e., from the expected trailers). In an embodiment, the shift plan data 32 may include an expected number and/or target number of multiple forms of packages, such as conveyable cartons, breakpack cartons, pallets, etc.

The labor plan data 34 may be or may include data indicative of labor availability and/or labor assignments for one or more shifts, days, or other period of time. The labor plan data 34 may include labor assignments for each individual dock within the warehouse, in an embodiment. The labor plan data 34 may additionally or alternatively include data respective of real-time labor availability, in an embodiment. Based on the labor plan data 34, in an embodiment, the warehouse management system 12 may be configured to determine the labor available at each dock within the warehouse at any given time. One or more components of the labor plan data (e.g., labor assignments for individual docks) may be calculated by the warehouse management system, in an embodiment, based on a broader information (such as total labor available for a given time period, such as a shift, day, week, etc.), in an embodiment.

The dock constraints data 36 may be or may include data indicative of capabilities or restrictions at individual docks with respect to the types of goods or forms of packages that can be loaded and/or unloaded at each dock. In other words, the dock constraints data may include rules that dictate what type of content (e.g., what forms of packages) may be assigned to each dock, in an embodiment. The dock constraints data 36 may include constraints that are applicable to all docks and/or constraints that are applicable to individual docks.

Constraints that may apply to every dock in a warehouse may include, for example: a requirement that a trailer 18 that is already at a dock be assigned to that dock; a requirement that each dock have only a single trailer 18 at it at any given time; and/or a requirement that every trailer 18 only be assigned to a single dock at a time.

Constraints that may apply to individual docks may include, for example: a minimum percentage or amount of a certain type of goods or type of package in the contents of a trailer; or a maximum percentage or amount of a certain type of goods or type of package in the contents of a trailer. Such individual dock constraints may be based on the equipment at or configuration of the dock and thus may reflect the package forms that the dock is best-equipped to unload. Stated another way, an individual dock constraint may include a minimum degree of fit between contents to be unloaded from a trailer 18 and the dock. For example, a particular dock may be associated with a constraint that at least seventy percent of a trailer's packages must be of a particular form (e.g., conveyable cartons) in order for that trailer 18 to be assigned to the dock.

In an embodiment, any individual dock of the plurality of docks may be associated with two or more individual constraints. For example, a given dock may be well-suited for unloading multiple forms of packages. Each of those types of package forms may be associated with a given constraint, and such constraints may be prioritized, in an embodiment. For example, in an embodiment, a given dock may be associated with a primary constraint that defines a minimum percentage of a first type of contents (e.g., first package form) of a trailer, and a secondary constraint that defines a minimum percentage of a second, different type of contents (e.g., second package form) of a trailer.

The labor constraints data 40 may be or may include relationships between types and/or amounts of trailer contents and labor required to work those content types and/or amounts. For example, the labor constraints data 40 may include data indicative of an amount of labor (e.g., in man-hours) required to unload a trailer 18 having a certain amount of a given type of goods. Accordingly, by applying the labor constraints data 40 to known contents of a trailer 18 (e.g., from the trailer contents data 28), the warehouse management system 12 may be able to determine the total amount of labor needed to unload that trailer 18. The labor constraints data may additionally or alternatively include an availability of certain types of labor for unloading certain types of packages, in an embodiment, which data may partially overlap with aspects of the labor plan data 34. The warehouse management system 12 may use that amount of labor for each of a plurality of trailers 18 in its determination of dock-to-trailer assignments.

The source constraints data 38 may include data indicative of particular docks that may be required for particular sources of goods. For example, the warehouse may have certain docks dedicated to certain sources (e.g., certain vendors or manufacturers of goods). Additionally or alternatively, certain sources may require unloading at docks having certain capabilities, which may be reflected in the source constraints data.

As described in this disclosure, the information stored in the dock constraints data 36, the source constraints 38, and the labor constraints data 40 may be expressed as constraints in a linear problem. Accordingly, the dock constraints data 36, the source constraints 38, and the labor constraints data 40 may be referred to for the remainder of this disclosure as dock constraints 36, source constraints 38, and labor constraints 40.

Some or all of the constraints (e.g., the dock constraints 36, the labor constraints 40, and/or the source constraints 38) may be associated with a priority, in an embodiment. That priority may be applied in the determination of trailer assignments. In addition, the warehouse management system 12 may provide the ability for a user to alter the priorities associated with one or more of the constraints. One or more of the constraints, however, may have priorities that are unchangeable.

As noted above, the warehouse management system 12 may be configured to arrange the data from the inventory management system 14, from the sensors 16, and/or from the data memory, as well as other data, in a linear problem. Arranging the linear problem may include defining certain variables within an objective function and defining certain data or relationships as constraints on that objective function. In an embodiment, the ages of each of a plurality of trailers 18 may be arranged as a variable in the objective function. Such a variable may account for the trailer age data 30. In an embodiment, the amount of labor needed to unload each of the trailers 18 may be arranged as a variable in the objective function. Such a variable may account for the labor plan data 34 and the trailer contents data 28.

In an embodiment, arranging the linear problem may also include expressing one or more desired relationships of the data stored in the data memory 24 and/or other data as constraints on the objective function. For example, in an embodiment, one or more of the relationships or requirements in the dock constraint data 36, the labor constraint data 40, and/or the source constraint data 38 may be expressed as constraints on the objective function in the linear problem.

The constraints of the linear problem may be expressed as either soft constraints (i.e., breakable constraints that penalize the objective function if broken) or hard constraints (i.e., constraints that must be satisfied by the solution). In embodiments, one or more dock constraints 36 may be expressed as soft constraints. For example, a dock-specific requirement for a minimum percentage or amount, and/or a maximum percentage or amount, of a certain type of goods or form of package in the contents of a trailer 18 may be expressed as a soft constraint, in an embodiment, such that a trailer having a percentage of the desired type of package lower than the constraint may still be permitted at the specific dock, but a solution including such an assignment may penalize the objective function relative to a solution that assigns a trailer to that specific dock that meets the minimum percentage constraint. In contrast, in an embodiment, a requirement that a trailer 18 that is already at a dock be assigned to that dock may be expressed as a hard constraint. In an embodiment, a requirement that a late trailer be assigned to a dock may be expressed as either a soft constraint or a hard constraint. For example, a late trailer constraint may be expressed as a soft constraint for trailers that are within a first “lateness” range, and may be expressed instead as a hard constraint for trailers that are within a second “lateness” range that applies to trailers that are older than trailers associated with the first lateness range.

The warehouse management system 12 may further be configured to output determined trailer assignments. Trailer assignment output may be in one or more of many forms. For example, in an embodiment, the warehouse management system 12 may output the trailer assignments to an electronic user interface for an operator of the warehouse to notify trailers 18 of assignments. Additionally or alternatively, in an embodiment, the warehouse management system 12 may be configured to automatically transmit trailer assignments to trailers 18 as they are determined, without requiring the warehouse operator to separately contact the trailer 18.

The warehouse management system 12 may be configured to make trailer assignment determinations on a periodic basis, in an embodiment. For example, the warehouse management system 12 may be configured to determine trailer assignments once per shift, twice per shift, once per hour, twice per hour, etc. The warehouse management system 12 may determine trailer assignments as often as is needed by the particular warehouse, in embodiments.

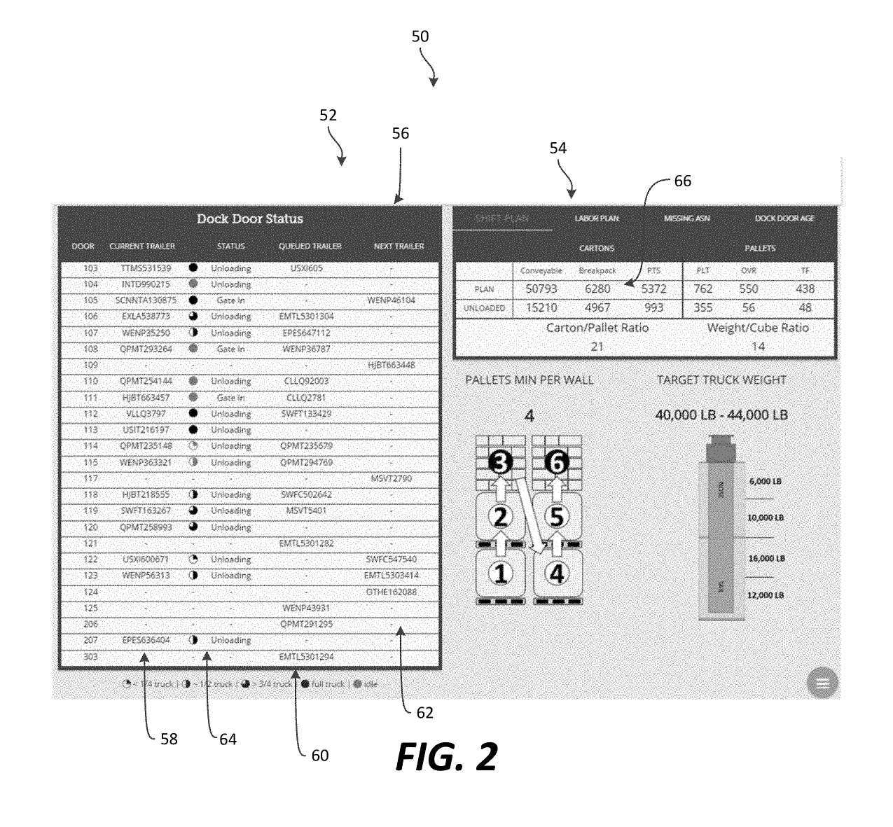

FIG. 2 is an example electronic user interface portion 50 that may be output by the system of FIG. 1. The user interface portion 50 may be provided by the warehouse management system 12 of FIG. 1, for example, to a computing system within the warehouse, in an embodiment, and/or to a computing system remote to the warehouse. Such a computing system may be or may include a personal computer, mobile device, or other appropriate computing system, in embodiments. The user interface 50 may be accessed by a user to review certain aspects of the operations of the warehouse such as, for example, review trailer assignments, to review one or more shift plans (which may reflect data stored in the shift plan data of FIG. 1), to review one or more labor plans (which may reflect data stored in the labor plan data of FIG. 1), in an embodiment. The user interface 50 may additionally or alternatively be accessed by a user to alter certain aspects of the warehouse such as, for example, alter priorities associated with certain constraints.

In an embodiment, the user interface 50 may include a dock assignment portion 52 and a data review portion 54. The dock assignment portion 52 may include, for example, an output listing 56 of trailer-to-dock assignments. The trailer-to-dock assignments may include, in an embodiment, a current dock assignment 58 (i.e., the current trailer at each dock or the trailer that currently should go to or be at each dock), a queued trailer assignment 60 (which may include trailers that should proceed to one or more docks after the current trailers at those docks are completed), and a next trailer assignment 62 (which may include trailers that should proceed to one or more docks after the queued trailers for those docks are completed). Thus, as illustrated in FIG. 2, a solution to a linear problem that may be solved by the warehouse management system may include up to three ordered trailer assignments per dock, in an embodiment. This specific number of ordered trailer assignments is an example only. The warehouse management system may be configured to determine any appropriate number of ordered trailer assignments per dock, in embodiments. For example, in an embodiment, the warehouse management system may be configured to determine trailer assignments for up to an entire shift.

The dock assignment portion 52 may further include one or more indicators 64 of the status of one or more trailers, in an embodiment. For example, as illustrated in FIG. 2, the dock assignment portion 52 may include a status descriptor (“Unloading,” “Gate In,” etc.) and/or indicators, such as Harvey balls, status bars, numerical percentages, etc., of the progress of unload of one or more trailers at the docks. Referring to FIGS. 1 and 2, the warehouse management system 12 may determine the unloading status of a trailer 18 based on the trailer contents data 28 in conjunction with data from the sensors 16. The warehouse management system 12 may be configured to update the status of trailers 18, and other information provided in the interface 50, substantially in real time.

The data review portion 54 may include an output of a shift plan, of a labor plan, or other information, as well as a substantially real-time status of one or more aspects of the warehouse. For example, the data review portion 54 may include a real-time status 66 of the unloading of particular content types (e.g., particular packaging forms) in the warehouse for a given shift (e.g., for comparison with the shift plan), a real-time status of the labor distribution within the warehouse (e.g., for comparison with the labor plan), or other information.

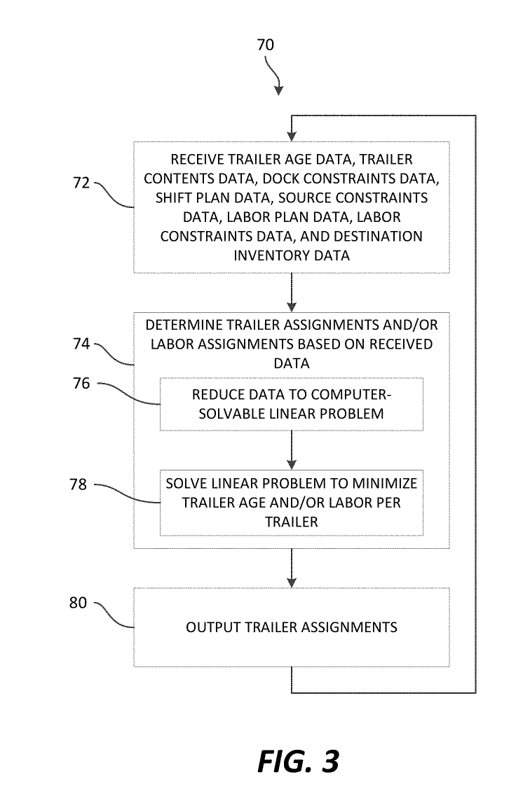

FIG. 3 is a flow chart illustrating an example embodiment of a method 70 for determining trailer assignments in a warehouse. For example, the method 70 may be applied to determine dock assignments for a plurality of trailers at a warehouse having a plurality of docks. Some or all of the method 70 may be executed by the warehouse management system 12 of FIG. 1, in an embodiment, to determine trailer-to-dock assignments in a warehouse, to determine labor assignments in a warehouse, and/or for other purposes. For ease of description, the method 70 will be described with reference to the system 10 of FIG. 1.

The method 70 may include a step 72 that includes receiving data including one or more of at least: trailer age data (e.g., an amount of time that each of a plurality of trailers has been at the warehouse), trailer contents data (e.g., contents to be unloaded from each of the plurality of trailers, such as the number of units of different package forms and/or the arrangement of those packages within the trailer), dock constraints data (e.g., content constraints of a plurality of docks in the warehouse), shift plan data (e.g., a minimum and/or a maximum amount of content to be unloaded at the warehouse within a predetermined period of time, desired density of outbound contents from the warehouse during the predetermined period of time), source constraints data (e.g., requirements that goods from certain sources be routed to certain docks), labor plan data (e.g., an amount of labor available in a given portion of the warehouse at a given time), labor constraints data (e.g., minimum labor-per-trailer requirements), and destination inventory data (e.g., needs of destinations of the contents to be unloaded from each of the plurality of trailers, such as indications that certain goods are out of stock or in low stock at certain destinations of goods to be unloaded from trailers). Data may be received from one or more storage devices associated with the processor 20 executing the method 70 (e.g., from the data memory 24), in an embodiment. Data may additionally or alternatively be received from the inventory management system 14 and/or from the sensors 16, in embodiments.

The method 70 may further include a step 74 that includes determining trailer-to-dock assignments and/or labor assignments based on the received data.

In an embodiment, the determining step 74 may include a sub-step 76 of reducing the received data to a computer-solvable linear problem. Reducing the received data to a computer-solvable linear problem may include defining an objective function having variables to be minimized or maximized. In an embodiment, the objective function may include (i) an amount of time that each of the plurality of trailers spends at the warehouse and (ii) an amount of labor used to achieve a required throughput for the warehouse for a given period of time. In other embodiments, additional or alternative values may be arranged in the objective function as variables to be minimized or maximized.

Reducing the received data to a linear problem may further include defining constraints on the linear problem. Such constraints may be based on the data received at step 72, in an embodiment. Constraints may include, for example, a minimum degree of fit between contents to be unloaded from a trailer and a dock to which it is assigned, a minimum quantity of contents to be unloaded at a dock, a maximum quantity of contents to be unloaded at a dock, a prohibited contents type at a dock, a minimum amount of labor per trailer, a minimum amount of labor per content type, a dock-specific requirement associated with a source of contents of a trailer, and/or a source-specific requirement associated with a dock. In embodiments, any of the constraints described in this disclosure, or any other useful constraints, may additionally or alternatively be used.

The determining step 74 may further include a sub-step 78 of solving the linear problem. The linear problem may be solved to minimize an amount of time that each of the plurality of trailers spends at the warehouse and/or to minimize an amount of labor used to load each of the plurality of trailers, in an embodiment. The solution to the linear problem may include assignments of one or more of the plurality of trailers to each of the plurality of docks, in an embodiment. The solution may include up to three ordered trailer assignments per dock, in an embodiment, or any other appropriate number of assignments per dock. The solution to the linear problem may further include details of a shift plan, in an embodiment, such as a target number of packages to be unloaded during the shift, target numbers of one or more types of packages, other target volume of goods to unload, a desired density of goods to flow through and/or be output from the warehouse, in an embodiment. That is, the solution may include a desired weight of goods per unit space in its outgoing trucks, which may be affected by the order in which inbound trailers are unloaded.

The method 70 may further include a step 80 that includes outputting the assignments. Outputting the assignments may include displaying the assignments on an electronic user interface (e.g., the electronic user interface 50 of FIG. 2 or similar interface), in an embodiment. Additionally or alternatively, outputting the assignments may include the warehouse management system 12 automatically transmitting the assignments to the trailers 18 to inform the trailers of their respective dock assignments.

The method 70 may be repeated periodically at a warehouse to determine trailer assignments and/or labor assignments. For example, in an embodiment, the method 70 may be repeated once or twice per shift. In another embodiment, the method 70 may be repeated once per hour. In another embodiment, the method 70 may be repeated once per half-hour. The method 70 may be repeated as often as is needed according to the needs of the warehouse.

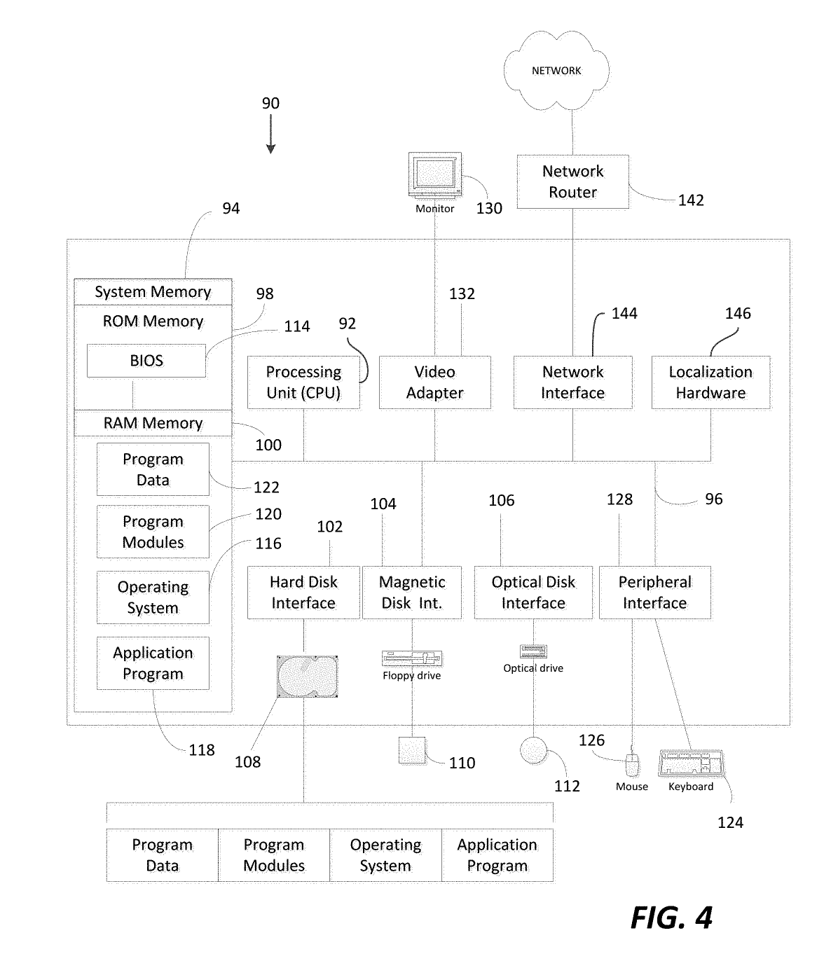

FIG. 4 is a diagrammatic view of an illustrative computing system that includes a general purpose computing system environment 90, such as a desktop computer, laptop, smartphone, tablet, or any other such device having the ability to execute instructions, such as those stored within a non-transient, computer-readable medium. Furthermore, while described and illustrated in the context of a single computing system 90, those skilled in the art will also appreciate that the various tasks described hereinafter may be practiced in a distributed environment having multiple computing systems 90 linked via a local or wide-area network in which the executable instructions may be associated with and/or executed by one or more of multiple computing systems 90.

In its most basic configuration, computing system environment 90 typically includes at least one processing unit 92 and at least one memory 94, which may be linked via a bus 96. Depending on the exact configuration and type of computing system environment, memory 94 may be volatile (such as RAM 100), non-volatile (such as ROM 98, flash memory, etc.) or some combination of the two. Computing system environment 90 may have additional features and/or functionality. For example, computing system environment 90 may also include additional storage (removable and/or non-removable) including, but not limited to, magnetic or optical disks, tape drives and/or flash drives. Such additional memory devices may be made accessible to the computing system environment 90 by means of, for example, a hard disk drive interface 102, a magnetic disk drive interface 104, and/or an optical disk drive interface 106. As will be understood, these devices, which would be linked to the system bus 96, respectively, allow for reading from and writing to a hard disk 108, reading from or writing to a removable magnetic disk 110, and/or for reading from or writing to a removable optical disk 112, such as a CD/DVD ROM or other optical media. The drive interfaces and their associated computer-readable media allow for the nonvolatile storage of computer readable instructions, data structures, program modules and other data for the computing system environment 90. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 90.

A number of program modules may be stored in one or more of the memory/media devices. For example, a basic input/output system (BIOS) 114, containing the basic routines that help to transfer information between elements within the computing system environment 90, such as during start-up, may be stored in ROM 98. Similarly, RAM 100, hard drive 108, and/or peripheral memory devices may be used to store computer executable instructions comprising an operating system 116, one or more applications programs 118 (such as the request management processes disclosed herein), other program modules 120, and/or program data 122. Still further, computer-executable instructions may be downloaded to the computing environment 90 as needed, for example, via a network connection.

An end-user, e.g., a customer, retail associate, and the like, may enter commands and information into the computing system environment 90 through input devices such as a keyboard 124 and/or a pointing device 126. While not illustrated, other input devices may include a microphone, a joystick, a game pad, a scanner, etc. These and other input devices would typically be connected to the processing unit 92 by means of a peripheral interface 128 which, in turn, would be coupled to bus 96. Input devices may be directly or indirectly connected to processor 92 via interfaces such as, for example, a parallel port, game port, firewire, or a universal serial bus (USB). To view information from the computing system environment 90, a monitor 130 or other type of display device may also be connected to bus 96 via an interface, such as via video adapter 132. In addition to the monitor 130, the computing system environment 90 may also include other peripheral output devices, not shown, such as speakers and printers.

The computing system environment 90 may also utilize logical connections to one or more computing system environments. Communications between the computing system environment 90 and the remote computing system environment may be exchanged via a further processing device, such a network router 142, that is responsible for network routing. Communications with the network router 142 may be performed via a network interface component 144. Thus, within such a networked environment, e.g., the Internet, World Wide Web, LAN, or other like type of wired or wireless network, it will be appreciated that program modules depicted relative to the computing system environment 90, or portions thereof, may be stored in the memory storage device(s) of the computing system environment 90.

The computing system environment 90 may also include localization hardware 146 for determining a location of the computing system environment 90. In embodiments, the localization hardware 146 may include, for example only, a GPS antenna, an RFID chip or reader, a WiFi antenna, or other computing hardware that may be used to capture or transmit signals that may be used to determine the location of the computing system environment 90.

The computing environment 90, or portions thereof, may comprise one or more of the warehouse management system 12, the inventory management system 14, and/or the sensors 16 of FIG. 1. Additionally, or alternatively, the computing environment 90, or portions thereof, may comprise a computing environment associated with one or more of the trailers 18 of FIG. 1.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system for organizing assignments of each of a plurality of trailers to a plurality of docks in a warehouse, comprising:
a non-transitory computer-readable memory containing computer-executable instructions; and
a processor configured to execute the instructions to:
(a) receive data comprising: (i) an amount of time that each of a plurality of trailers has been at the warehouse; (ii) contents to be unloaded from each of the plurality of trailers; and (iii) content constraints associated with a plurality of docks in a warehouse;
(b) reduce the data to a computer-solvable linear problem;
(c) solve the linear problem to minimize an amount of time that each of the plurality of trailers spends at the warehouse, wherein the solution to the linear problem comprises an assignment of one of the plurality of trailers to one of the plurality of docks; and
(d) output the assignments.

2. The system of claim 1, wherein the processor is configured to output the assignment by populating an electronic user interface with the assignment to enable a user to contact at least one of the plurality of trailers with the assignment.

3. The system of claim 2, wherein the user interface comprises one or more of:
a real-time status of each of the plurality of docks;
a real-time status of a volume of contents unloaded at the warehouse; or
a target volume of contents to be unloaded at the warehouse.

4. The system of claim 1, wherein the processor is configured to output the assignment by automatically transmitting the assignment to at least one of the plurality of trailers.

5. The system of claim 1, wherein the processor is configured to repeat (a), (b), (c), and (d) periodically.

6. The system of claim 1, wherein the data further comprises (iv) needs of destinations of the contents to be unloaded from each of the plurality of trailers; (v) a minimum and a maximum amount of content to be unloaded at the warehouse within a predetermined period of time; and (vi) a desired density of outbound contents from the warehouse during the predetermined period of time.

7. The system of claim 1, wherein the content constraints associated with the plurality of docks comprise:
a minimum degree of fit between contents to be unloaded from a trailer and a dock to which it is assigned;
a minimum quantity of contents to be unloaded associated with a dock;
a maximum quantity of contents to be unloaded associated with a dock; and
a prohibited contents type associated with a dock.

8. The system of claim 1, wherein the linear problem comprises further constraints comprising:
a minimum amount of labor per trailer; and
a minimum amount of labor per content type.

9. The system of claim 1, wherein the linear problem comprises further constraints comprising:
dock-specific requirements associated with a source of contents of a trailer; and
source-specific requirements associated with a dock.

10. The system of claim 9, wherein the linear problem is solved further to minimize an amount of labor used to load each of the plurality of trailers.

11. The system of claim 1, further comprising:
a sensor disposed in the warehouse and configured to provide status data respective of the unloading status of a trailer;
wherein the processor is in electronic communication with the sensor and the data received by the processor further comprises the status data.

12. A method for organizing assignments of each of a plurality of trailers to a plurality of docks in a warehouse, comprising:
(a) receiving data comprising: (i) an amount of time that each of a plurality of trailers has been at the warehouse; (ii) contents to be unloaded from each of the plurality of trailers; and (iii) content constraints associated with a plurality of docks in a warehouse;
(b) reducing the data to a computer-solvable linear problem;
(c) solving the linear problem with a processor to minimize an amount of time that each of the plurality of trailers spends at the warehouse, wherein the solution to the linear problem comprises assignments of one of the plurality of trailers to one of the plurality of docks; and
(d) outputting the assignment.

13. The method of claim 12, wherein outputting the assignment comprises populating an electronic user interface with the assignment to enable a user to contact at least one of the plurality of trailers with the assignment.

14. The method of claim 13, wherein the user interface comprises one or more of:
a real-time status of each of the plurality of docks;
a real-time status of a volume of contents unloaded at the warehouse; or
a target volume of contents to be unloaded at the warehouse.

15. The method of claim 12, wherein outputting the assignment comprises automatically transmitting the assignment to at least one of the plurality of trailers.

16. The method of claim 12, further comprising repeating (a), (b), (c), and (d) periodically.

17. The method of claim 12, wherein the data further comprises (iv) needs of destinations of the contents to be unloaded from each of the plurality of trailers; (v) a minimum and a maximum amount of content to be unloaded at the warehouse within a predetermined period of time; and (vi) a desired density of outbound contents from the warehouse during the predetermined period of time.

18. The method of claim 12, wherein the content constraints associated with the plurality of docks comprise:
a minimum degree of fit between contents to be unloaded from a trailer and a dock to which it is assigned;
a minimum quantity of contents to be unloaded associated with a dock;
a maximum quantity of contents to be unloaded associated with a dock; and
a prohibited contents type associated with a dock.

19. The method of claim 12, wherein the linear problem comprises further constraints comprising:
a minimum amount of labor per trailer; and
a minimum amount of labor per content type.

20. The method of claim 12, wherein the linear problem comprises further constraints comprising:
dock-specific requirements associated with a source of contents of a trailer; and
source-specific requirements associated with a dock.

21. The method of claim 20, wherein the linear problem is solved further to minimize an amount of labor used to load each of the plurality of trailers.
